(19) United States
(12) Patent Application Publication
(10) Pub. No.: US 2026/0166747 A1
(43) Pub. Date: Jun. 18, 2026

(54) METHOD AND DEVICE WITH ROBOT MOVEMENT CONTROL

(71) Applicant: Samsung Electronics Co., Ltd., Suwon-si (KR)

(72) Inventors: Sung Hyun CHUNG, Suwon-si (KR); Inseop CHUNG, Suwon-si (KR); Junho CHO, Suwon-si (KR); Kapje SUNG, Suwon-si (KR); Jinhyuk CHOI, Suwon-si (KR)

(73) Assignee: Samsung Electronics Co., Ltd., Suwon-si (KR)

(21) Appl. No.: 19/226,985

(22) Filed: Jun. 3, 2025

(30) Foreign Application Priority Data
Dec. 17, 2024 (KR) 10-2024-0188968

(51) Int. Cl. B25J 9/16; B25J 19/02

(52) U.S. Cl. CPC B25J 9/1697; B25J 9/1661; B25J 19/023

(57) ABSTRACT

A method of controlling a robot is disclosed. The method includes obtaining an input prompt indicating a task of the robot, obtaining a first image for the robot, determining whether a set of sub-tasks to accomplish the task is in effect. When the set of sub-tasks is not in effect, obtaining the set of sub-tasks and an initial control signal of the robot by inputting first input data and second input data to an analysis model. When the set of sub-tasks is in effect and the robot performs a first sub-task of the set of sub-tasks, obtaining a first control signal of the robot by inputting third input and fourth input data to the analysis model, and transmitting the initial control signal or the first control signal to the robot.

### CROSS-REFERENCE TO RELATED APPLICATIONS

This application claims the benefit under 35 USC § 119(a) of Korean Patent Application No. 10-2024-0188968, filed on Dec. 17, 2024, in the Korean Intellectual Property Office, the entire disclosure of which is incorporated herein by reference for all purposes.

### BACKGROUND

### 1. Field

The following description relates to technology for controlling a robot, and more particularly, for determining a movement of a robot to perform a task based on an image and an input prompt.

### 2. Description of Related Art

Robot control technology may involve performing a task along a pre-programmed path or performing an action that is set based on a certain sensor input. Such a method has difficulty in flexibly responding to changes in an environment and has limitations in interpreting vision information and language information and performing an appropriate task. Accordingly, the need for vision language action (VLA) technology that may understand natural language instructions and images of humans and autonomously perform a task based on the natural language instructions and images has arisen. VLA technology recognizes a visual environment through an image by a robot, interprets instructions transmitted in a natural language, and controls the robot to perform an accurate and effective action based on this.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of controlling a robot includes: obtaining an input prompt indicating a task of the robot; obtaining a first image for the robot; determining which of a first process or a second process will be performed by determining whether a set of sub-tasks to accomplish the task is in effect; the first process including obtaining the set of sub-tasks to accomplish the task and an initial control signal of the robot to accomplish a first sub-task of the set of sub-tasks by inputting, to an analysis model, first input data generated based on the input prompt and second input data generated based on the first image, and transmitting the initial control signal to or within the robot; the second process including obtaining a first control signal of the robot to accomplish the first sub-task of the set of sub-tasks by inputting, to the analysis model, third input data generated based on the input prompt and at least one control signal generated to accomplish the first sub-task and fourth input data generated based on the first image, and transmitting the first control signal to or within the robot; and performing whichever of the first and second processes is determined to be performed.

The first process may be performed, and the method may further include: based on determining that the first sub-task has been accomplished by the robot according to the initial control signal, updating a sub-task state of the robot, the updating causing the robot to perform a second sub-task of the set of sub-tasks.

The second process may be performed, and the method may further include: based on determining that the set of sub-tasks is invalid, obtaining a new set of sub-tasks for accomplishing the task and a new initial control signal of the robot to accomplish a first sub-task of the new set of sub-tasks by inputting the first input data and the second input data to the analysis model.

The set of sub-tasks may be determined to be invalid based on determining that a time required to perform the first sub-task exceeds a reference time or based on determining that a number of control signals, including the new initial control signal, obtained to perform the first sub-task exceeds a reference number.

The first input data may be generated based on the input prompt and sub-tasks previously generated to accomplish the task.

The second input data or the fourth input data may be generated based on the first image and a second image captured before the first image was captured.

The analysis model may be implemented based on all or part of a neural network, a transformer, a large language model (LLM), a vision language model (VLM), or a vision language action (VLA) model.

In another general aspect, an electronic device for controlling a robot device includes: at least one processor including processing circuitry, memory storing instructions that, when executed by the at least one processor individually or collectively, cause the electronic device to: obtain an input prompt indicating a task of the robot; obtain a first image for the robot; determine which of a first process or a second process will be performed by determining whether a set of sub-tasks to accomplish the task is in effect; wherein the first process includes obtaining the set of sub-tasks to accomplish the task and an initial control signal of the robot to accomplish a first sub-task of the set of sub-tasks by inputting, to an analysis model, first input data generated based on the input prompt and second input data generated based on the first image, and transmitting the initial control signal to or within the robot; wherein the second process includes obtaining a first control signal of the robot to accomplish the first sub-task of the set of sub-tasks by inputting, to the analysis model, third input data generated based on the input prompt and at least one control signal generated to accomplish the first sub-task and fourth input data generated based on the first image, and transmitting the first control signal to or within the robot; and perform whichever of the first and second processes is determined to be performed.

The first process may be performed, and the instructions, when executed by the at least one processor individually or collectively, may be further cause the electronic device to: based on determining that the first sub-task has been accomplished by the robot according to the initial control signal, update a sub-task state of the robot, the updating causing the robot to perform a second sub-task of the set of sub-tasks.

The second process may be performed, and the instructions, when executed by the at least one processor individually or collectively, may be further cause the electronic device to: based on determining that the set of sub-tasks is invalid, obtain a new set of sub-tasks for accomplishing the task and a new initial control signal of the robot to accomplish a sub-task to be first performed of the new set of sub-tasks by inputting the first input data and the second input data to the analysis model.

The instructions, when executed by the at least one processor individually or collectively, may be further cause the electronic device to determine that the set of sub-tasks is invalid based on determining that a time required to perform the first sub-task exceeds a reference time or based on determining that a number of control signals, including the new initial control signal, obtained to perform the first sub-task exceeds a reference number.

The first input data may be generated based on the input prompt and sub-tasks previously generated to accomplish the task.

The second input data or the fourth input data may be generated based on the first image and a second image captured before the first image was captured.

The analysis model may be implemented based on all or part of a neural network, a transformer, a large language model (LLM), a vision language model (VLM), or a vision language action (VLA) model.

In another general aspect, a method of controlling a robot includes: obtaining an input prompt indicating a task of the robot; obtaining a first image for the robot; determining whether a set of sub-tasks to accomplish the task is in effect; based on determining that the set of sub-tasks is in effect and the robot performing a first sub-task of the set of sub-tasks, obtaining a first control signal of the robot to accomplish the first sub-task by inputting, to an analysis model, third input data generated based on the input prompt and at least one control signal generated to accomplish the first sub-task and fourth input data generated based on the first image, and transmitting the first control signal to or within the robot.

The method may further include: obtaining a second input prompt indicating a second task of the robot; obtaining a second image for the robot; based on determining that a set of sub-tasks for the second task is not in effect, generating a second set of sub-tasks to accomplish the second task by inputting, to the analysis model, first input data generated based on the second input prompt and second input data generated based on the second image.

The method may further include: in response to the set of sub-tasks being determined to be in effect and the robot performing the first sub-task of the set of sub-tasks, determining whether the set of sub-tasks is valid; generating a new set of sub-tasks to accomplish the task and an initial control signal of the robot to accomplish a first sub-task of the new set of sub-tasks by inputting, to the analysis model, first input data generated based on the input prompt and second input data generated based on the first image, in response to the set of sub-tasks being determined to be invalid; and transmitting the initial control signal to the robot.

The set of sub-tasks may be determined to be invalid based on a time required to perform the first sub-task exceeding a reference time or based on a number of control signals obtained to perform the first sub-task exceeding a reference number.

The analysis model may be implemented based on all or part of a neural network, a transformer, a large language model (LLM), a vision language model (VLM), or a vision language action (VLA) model.

A non-transitory computer-readable storage medium storing instructions that, when executed by a processor, cause the processor to perform any of the methods.

Other features and aspects will be apparent from the following detailed description, the drawings, and the claims.

### BRIEF DESCRIPTION OF THE DRAWINGS

FIG. 1 illustrates an example of an operation in which an electronic device obtains a control signal to control a robot, according to one or more embodiments.

FIG. 2 illustrates an example of a configuration of an electronic device, according to one or more embodiments.

FIG. 3 illustrates an example of a method of controlling a robot, according to one or more embodiments.

FIG. 4 illustrates an example of an operation in which an electronic device generates a plan-output and an action-output in a plan mode, according to one or more embodiments.

FIG. 5 illustrates an example of an operation in which an electronic device generates an action-output in an action mode, according to one or more embodiments.

FIG. 6 illustrates an example of a method of updating a sub-task state of a robot, according to one or more embodiments.

FIG. 7 illustrates an example of a method of controlling a robot based on whether a set of sub-tasks is valid, according to one or more embodiments.

FIG. 8 illustrates an example of a method of determining whether a set of sub-tasks is valid, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

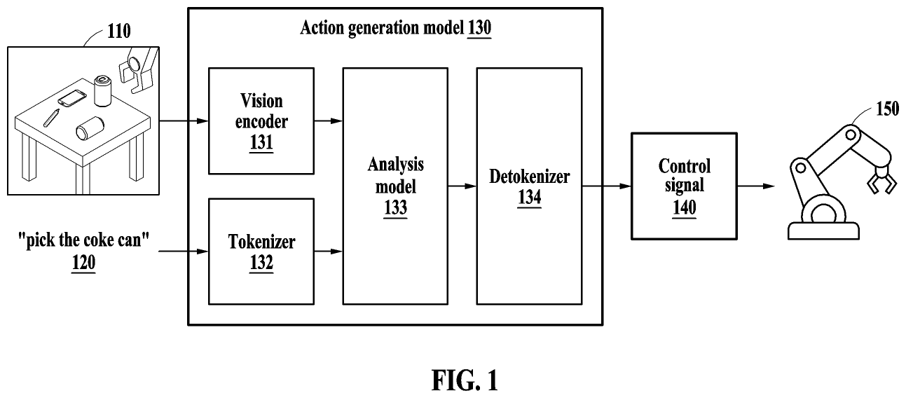

FIG. 1 illustrates an example of an operation in which an electronic device obtains a control signal to control a robot, according to one or more embodiments.

The electronic device may include an action generation model 130 that may obtain a control signal 140 of a robot 150 based on an image 110 and an input prompt 120. The electronic device may be a communication device, such as a smartphone or the like, a vehicle, such as an automobile or the like, a consumer electronic apparatus, such as a washing machine and the like, a manufacturing apparatus, or the like. For example, the robot 150 may be a robot arm, a humanoid, or an autonomous vehicle. The type of robot 150 is not limited to the described example, and other types of robots that may accomplish a task by changing a state according to the control signal 140 may exist. The task may be any that the robot 150 may perform based on an instruction (e.g., the input prompt 120) input to the robot 150. For example, as illustrated in FIG. 1, in response to the input prompt 120, “pick the Coke can,” the task of picking a Coke can may be input to the robot 150 in a situation in which a Coke can exists.

The image 110 may be obtained (e.g., captured) with respect to a situation in which robot 150 and a part of the robot 150 perform the task. The image 110 may be obtained by a camera mounted on the robot 150. However, examples are not limited thereto, and the image 110 may be obtained by a camera installed as a separate device from the robot 150.

At least a part of the robot 150 shown in the image 110 may include a part that performs the task. The part of the robot 150 that performs the task may also be referred to as an end effector. The end effector is a device that may be positioned, for example, at one end of the robot 150 and may be used as a tool that performs the task. As non-limiting examples, the end effector may be a gripper, a welding tool, a spray-painting tool, or a sensor. The image 110 may indicate an environment or a state corresponding to one of the following timepoints: before performing the task, during performing the task, or after performing the task.

The input prompt 120 may include text indicating the task of the robot 150. For example, the input prompt 120 may be a natural language instruction that is input by a user. For example, the input prompt 120 may be text that is converted to be input to the action generation model 130 as the natural language instruction that is input by the user is processed.

The electronic device may generate the control signal 140 of the robot 150 to perform the task corresponding to the input prompt 120 based on a situation in which at least a part (e.g., an end effector) of the robot 150 shown in the image 110 and the robot 150 perform the task. The control signal 140 may indicate, among all operations of the robot 150 (or an end effector of the robot 150) available to be performed to perform the task, a unit operation and/or an extremely small operation performed in a situation shown in the image 110 (e.g., an actuation).

The control signal 140 may include a position change (e.g., translation) of at least a part (e.g., an end effector) of the robot 150, an amount of rotation of at least a part (e.g., an end effector) of the robot 150, and/or a variation in grip intensity of at least a part (e.g., an end effector) of the robot 150.

The position change may be according to each of axes. For example, the position change may be with respect to three degrees of freedom and may include (i) a position change according to a first axis (e.g., an x-axis), (ii) a position change according to a second axis (e.g., a y-axis) that is perpendicular to the first axis, and (ii) a position change according to a third axis (e.g., a z-axis) that is perpendicular to the first axis and the second axis. Here, the first axis, the second axis, and the third axis (e.g., the x-axis, the y-axis, and the z-axis) may refer to the axes of a three-dimensional (3D) orthogonal coordinate system, which is a device coordinate system determined based on the robot 150 (or a camera mounted on the robot 150). That is, the three translation axes may be in a frame of reference of the robot 150.

The amount of rotation may include a rotation angle according to each of axes. For example, the amount of rotation may be with respect to three degrees of freedom and my include (i) a rotation angle (e.g., a roll angle) according to a first axis (e.g., a longitudinal axis), (ii) a rotation angle (e.g., a pitch angle) according to a second axis (e.g., a lateral axis), and (iii) a rotation angle (e.g., a yaw angle) according to a third axis (e.g., a vertical axis). Here, the first axis, the second axis, and the third axis may refer to the axes of a 3D orthogonal coordinate system, which is a device coordinate system determined based on the robot 150 (or a camera mounted on the robot 150). That is, the three rotation axes may be in a frame of reference of the robot 150.

The variation in grip intensity may include a variation in grip intensity when the end effector of the robot 150 is a gripper.

The electronic device may obtain/generate the control signal 140 of the robot 150 from the image 110 and the input prompt 120 using the action generation model 130. The action generation model 130 may include a vision encoder 131, a tokenizer 132, an analysis model 133, and a detokenizer 134.

The vision encoder 131 may generate input data to be inputted to the analysis model 133, and may do so by extracting image feature data (e.g., an image feature vector or an image feature map) from the image 110. The vision encoder 131 may output the image feature data by preprocessing the input image 110 and extracting a feature from the image 110 that has been preprocessed. The preprocessing the image 110 may include adjusting the size of the image 110 and normalizing data (e.g., a pixel value) of the image 110. The extracting of the feature from the preprocessed image 110 may include performing a convolution using a kernel and a pooling process (e.g., for pooling feature maps obtained through the convolution). For example, the vision encoder 131 may include, but is not limited thereto, a CNN-based encoder, a transformer-based encoder, an autoencoder, or any combination thereof.

The vision encoder 131 may include an image tokenizer and the vision encoder 131 may obtain one or more image tokens from the image tokenizer (based on inputting of which the extracted image feature data thereto). In this context, a token is an information unit and may include symbolic representation suited/configured for processing by the analysis model 133. The image tokens may be processed by the analysis model 133 as input data inputted to the analysis model 133.

Another tokenizer, the tokenizer 132, may perform an operation to extract one or more text tokens from text. For example, the tokenizer 132 may generate text tokens based on the input prompt 120. For example, the tokenizer 132 may generate text tokens based on the input prompt 120 and based on information (e.g., a history of outputs generated in the action generation model 130) stored in a memory. The text tokens may be processed by the analysis model 133 as input data inputted to the analysis model 133.

The analysis model 133 may generate an output token by processing the image tokens and/or the text tokens. For example, the analysis model 133 may be implemented based on all or part of at least one of a neural network (e.g., a convolution neural network (CNN)), a transformer, or a large language model (LLM), as non-limiting examples. For example, the output token may indicate information about the control signal 140. Specifically, the output token may indicate information about a set of sub-tasks, which may include sub-tasks indicating each of stage-by-stage tasks to accomplish the task.

The detokenizer 134 may perform an operation to generate an output from the output token; the output token obtained/generated by the analysis model 133. For example, the detokenizer 134 may generate an action-output indicating the control signal 140 of the robot 150 and/or a plan-output indicating the set of sub-tasks.

The electronic device may determine/generate the control signal 140 of the robot 150 based on the set of sub-tasks for accomplishing the task. For example, the electronic device may determine the control signal 140 of the robot 150 to accomplish a sub-task of the set of sub-tasks, which is currently being performed (that is, the control signal 140 may be specific to one of the sub-tasks). The electronic device may accomplish the task by performing the next sub-task (e.g., by generating another control signal therefor) or modifying the set of sub-tasks based on the success or failure of the sub-task that is currently being performed.

The electronic device may control the robot 150 based on the control signal 140 of the robot 150. The electronic device may be implemented integrally (e.g., as a single electronic device) with the robot 150. The electronic device use the control signal 140 to control a driver of the robot 150. The electronic device may be implemented separately (e.g., as a separate electronic device) from the robot 150. The electronic device may transmit, to the robot 150, a control instruction based on the control signal 140. The robot 150 may drive at least a part of the robot 150 in response to the control instruction received from the electronic device.

The electronic device may obtain an additional image after the robot 150 moves at least a part of the robot 150 based on the control signal 140. As a result of at least a part of the robot 150 moving based on the control signal 140, an environment (or state) shown in the additional image may be different than the environment (or state) shown in the image 110. The electronic device may generate the control signal 140 based on the input prompt 120 and the additional image and may accordingly control at least a part of the robot 150. The electronic device may generate a series of control signals to perform the task (or one of sub-tasks) by repeatedly driving the robot 150 according to the control signal 140 based on the image 110 and changing (e.g., updating) the image 110 reflecting the environmental change according to the driving of the robot 150 across multiple images inputted to the action generation model 130.

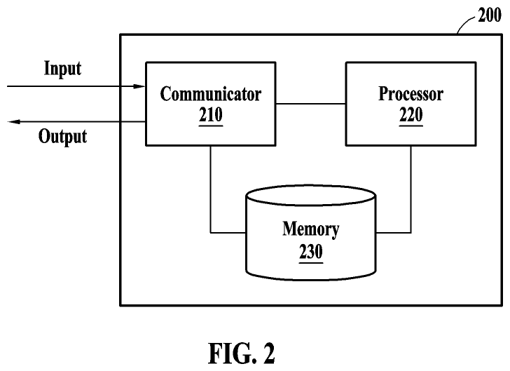

FIG. 2 illustrates an example of a configuration of an electronic device, according to one or more embodiments.

An electronic device 200 (e.g., the electronic device including the action generation model 130 of FIG. 1) may include a communicator 210, a processor 220, and a memory 230.

The communicator 210 may be connected to the processor 220, the memory 230, and a robot (e.g., the robot 150 of FIG. 1) to transmit and receive data to and from the processor 220, the memory 230, and the robot. The communicator 210 may be connected to another external device to transmit and receive data to and from the external device. Hereinafter, transmitting and receiving “A” may refer to transmitting and receiving “information or data indicating A.”

The communicator 210 may be implemented as circuitry in the electronic device 200. For example, the communicator 210 may include an internal bus and an external bus. In another example, the communicator 210 may be an element that connects the electronic device 200 to the external device. The communicator 210 may be an interface. The communicator 210 may receive data from the external device and transmit the data to the processor 220 and the memory 230.

The processor 220 may process data received by the communicator 210 and data stored in the memory 230. The “processor” may be a data processing device implemented by hardware including a circuit having a physical structure to perform desired operations. For example, the desired operations may be specified by code or instructions included in a program. For example, the hardware-implemented data processing device may include, as the processor 220, a microprocessor, a central processing unit (CPU), a processor core, a multi-core processor, a multiprocessor, an application-specific integrated circuit (ASIC), and/or a field-programmable gate array (FPGA).

The processor 220 may execute computer-readable code (e.g., software/instructions) stored in a memory (e.g., the memory 230) and instructions triggered by the processor 220. For example, a method in which the electronic device 200 controls the robot may be performed by executing the instructions.

The memory 230 may store data received by the communicator 210 and data processed by the processor 220. For example, the memory 230 may store a program (or an application or software). The program to be stored may be a set of syntaxes that are coded and executable by the processor 220 to provide a method of controlling the robot.

The memory 230 may include, for example, at least one volatile memory, non-volatile memory, random-access memory (RAM), flash memory, a hard disk drive, and an optical disk drive.

The memory 230 may store instructions (e.g., software) for operating the electronic device 200. The instruction set for operating the electronic device 200 may be executed by the processor 220.

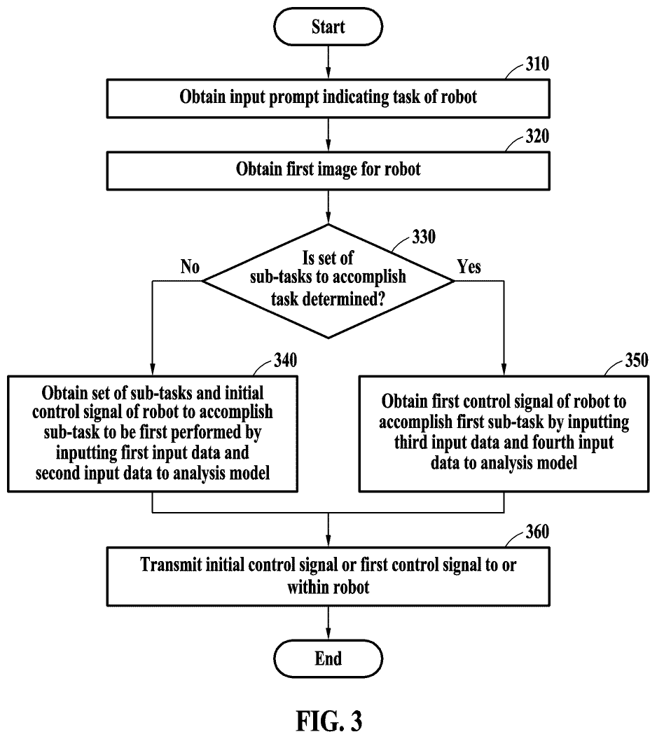

FIG. 3 illustrates an example of a method of controlling a robot, according to one or more embodiments.

Operations 310 to 360 may be performed by an electronic device (e.g., the electronic device including the action generation model 130 of FIG. 1 or the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2).

The electronic device may include an action generation model (e.g., the action generation model 130 of FIG. 1), and based on a first image (e.g., the image 110 of FIG. 1) and an input prompt (e.g., the input prompt 120 of FIG. 1), may obtain a control signal of a robot to accomplish a task indicated by the input prompt. The action generation model may refer to a model generated and/or trained to output, from input data corresponding to the input prompt and the first image, output data corresponding to the control signal of the robot. The action generation model may be implemented based on all or part of at least one of a neural network (e.g., a CNN), a transformer, an LLM, a vision language model (VLM), and/or a vision language action (VLA) model, as non-limiting examples.

In operation 310, the electronic device may obtain the input prompt indicating a task of the robot. For example, the input prompt may be a natural language instruction that is input by a user. For example, the input prompt may be text that is converted to be input to the action generation model as the natural language instruction that is input by the user.

In operation 320, the electronic device may obtain the first image for the robot. For example, the first image may be an image obtained (e.g., captured) with respect to a situation in which the robot and at least a part of the robot perform a task. The first image may indicate an environment or a state corresponding to one of the following timepoints: before performing the task, during performing the task, or after performing the task. The first image may pixels with respective pixel values (e.g., an R value, a G value, and a B value, and possibly a depth value).

In operation 330, the electronic device may determine whether a set of sub-tasks to accomplish a task is determined (e.g., whether sub-tasks for a plan are already underway, or, are in effect). The set of sub-tasks may be determined by a plan-output that is generated by the electronic device. The set of sub-tasks may include sub-tasks indicating stage-by-stage tasks (sub-tasks) to accomplish the task, and the set of sub-tasks may be generated in response to the task of the robot as indicated by the input prompt inputted by the user. For example, in response to the task indicated by the input prompt, “pick a Coke can,” the set of sub-tasks may include a sub-task (e.g., “default position”) that positions an end effector at a default position, a sub-task (e.g., “move end effector to Coke can”) that moves the end effector to the position of a Coke can, a sub-task (e.g., “try grab Coke can”) that grabs the Coke can using the end effector, a sub-task (e.g., “lifting end effector with can”) that lifts the end effector with the Coke can, and a sub-task (e.g., finished) that finishes the movement of the robot.

For example, whether the set of sub-tasks is determined may be determined based on a sub-task state of the robot. The sub-task state of the robot may be a parameter indicating information about the sub-task that the robot performs. For example, in the sub-task state of the robot, when the information about the sub-task is not displayed or set, the electronic device may determine that the sub-task to accomplish the task is not determined.

In such a case, the electronic device may operate in a plan mode or in an action mode. For example, depending on whether the electronic device is in the plan mode or in the action mode, the electronic device may differently generate pieces of input data to be input to an analysis model (e.g., the analysis model 133 of FIG. 1) and may input, to the analysis model together with the pieces of input data, the parameter that differently specifies contents of an output token to be generated by the analysis model. In other words, the action generation model 130, for example, may generate one set of input data (for the analysis model) for an input thereto when in the plan mode, and may generate another set of (for the analysis model) when in the action mode. In the plan mode, the electronic device may generate a plan-output that determines a plan (e.g., a set of sub-tasks) to accomplish the task based on first input data (e.g., a text prompt) and second input data (e.g., an image). In the action mode, the electronic device may generate an action-output that determines a movement (e.g., a control signal) of the robot so that a sub-task that is currently being performed is accomplished; such movement determination may be performed in a situation in which the first image is obtained based on third input data and fourth input data. For example, in the plan mode, the electronic device may generate, together with the plan-output, the action-output that determines the movement of the robot so that a first sub-task to be performed in the plan (to accomplish the task) is accomplished. Put another way, when in the plan mode, the action generation model may generate a plan and an action, and in the action mode, the action generation model may generate an action but not a plan.

In operation 340, when a set of sub-tasks is not already underway (being implemented), i.e., operation 330 is “No”), the electronic device may operate in the plan mode to determine the set of sub-tasks when the set of sub-tasks is not determined. The electronic device may obtain/generate the set of sub-tasks to accomplish the task and an initial control signal of the robot to accomplish the first sub-task (order-wise) of the set of sub-tasks by inputting, to the analysis model, the first input data generated based on the input prompt and the second input data generated based on the first image.

For example, the first input data may be text tokens generated by a tokenizer (e.g., the tokenizer 132 of FIG. 1) included in the electronic device, and the second input data may be image tokens generated by a vision encoder (e.g., the vision encoder 131 of FIG. 1) included in the electronic device. For example, as the first input data and the second input data are input to the analysis model, based thereon the output token may be generated, and as the output token is input to a detokenizer (e.g., the detokenizer 134 of FIG. 1), the plan-output indicating the set of sub-tasks and an initial action-output indicating the initial control signal may also be generated.

For example, when a previously determined set of sub-tasks is determined to be invalid (e.g., it is impossible to accomplish the task with the previously determined set of sub-tasks), the electronic device may reenter the plan mode by discarding the previously determined set of sub-tasks.

The first input data may be generated based on the input prompt and a plan-output history. For example, the plan-output history may indicate the previously generated set of sub-tasks (previously generated to accomplish the task), the degree to which the previously generated set of sub-tasks progressed, or a reason why the previously progressed set of sub-tasks was determined to be invalid. For example, the electronic device may generate the first input data based on the result of concatenating the input prompt with the plan-output history. The electronic device may reflect the plan-output history in the generation of a new plan-output by using the plan-output history for the generation of the first input data together with the input prompt indicating the task. The electronic device may generate the plan-output, which may indicate an improved set of sub-tasks based on feedback on the previously generated plan-output.

The second input data may be generated based on the first image and a second image that was previously obtained. The electronic device may generate, as the second input data, image tokens that accurately indicate an environment or a state corresponding to the first image by extracting image feature data of the first image with reference to a previously obtained image.

The electronic device may obtain the set of sub-tasks and the initial control signal by inputting, to the analysis model, fifth input data generated based on a signal sensed by a sensor that is related to operations, together with the first input data and the second input data. The signal may be obtained with respect to a situation in which the robot or at least a part of the robot performs the task. For example, the signal may indicate information about sound, pressure, temperature, location/orientation, distance, etc., but the type of sensed information is not limited thereto. The signal may be obtained by a sensor mounted on the robot. However, examples are not limited thereto, and the signal may also be obtained by a sensor installed as a separate device from the robot. For example, the fifth input data may be generated as the signal sensed by the sensor is processed by a signal encoder.

In contrast, when operation 330 results in a “Yes” (a previously set of sub-tasks is underway), operation 350 may be performed. Specifically, the electronic device may operate in the action mode to determine the control signal of the robot when a set of sub-tasks is determined (is underway) and the robot is performing, or starting performance of, the first sub-task of the set of sub-tasks. The electronic device may obtain/generate a first control signal of the robot to accomplish the first sub-task by inputting, to the analysis model, (i) the third input data generated based on the input prompt and at least one control signal generated to accomplish the first sub-task and (ii) the fourth input data generated based on the first image.

For example, the third input data may be text tokens generated by the tokenizer included in the electronic device. For example, the fourth input data may be image tokens generated by the vision encoder included in the electronic device. For example, as the third input data and the fourth input data are input to the analysis model, the output tokens may be generated, and as the output tokens are input to the detokenizer, a first action-output indicating the first control signal may be generated.

The third input data may be generated based on the input prompt and an action-output history. For example, the action-output history may include contents of the first sub-task, a coordinate of an object detected in relation to the first sub-task, a state of the end effector at the time the first sub-task is to be performed, or at least one control signal generated to accomplish the first sub-task. For example, the electronic device may generate the third input data based on the result of concatenating the input prompt with the action-output history. The electronic device may reflect the action-output history in the generation of a new action-output by using the action-output history for the generation of the third input data together with the input prompt indicating the task. The electronic device may generate an action-output that may accurately control the robot based on feedback on the previously generated action-output.

The fourth input data may be generated based on the first image and the previously obtained second image. The electronic device may generate, as the fourth input data, the image tokens that accurately indicate an environment or a state corresponding to the first image by extracting the image feature data of the first image with reference to a previously obtained image.

The electronic device may obtain the first control signal by inputting, to the analysis model, sixth input data generated based on a signal sensed by a sensor related to operations, together with the third input data and the fourth input data. The sensed signal may be obtained with respect to a situation in which the robot or at least a part of the robot performs the task. For example, the signal may indicate information about sound, pressure, temperature, location/orientation, distance, etc., but the type of sensed information is not limited thereto. The signal may be obtained by a sensor mounted on the robot. However, examples are not limited thereto, and the signal may also be obtained by a sensor installed as a separate device from the robot. For example, the sixth input data may be generated as a signal sensed by a sensor is processed by a signal encoder.

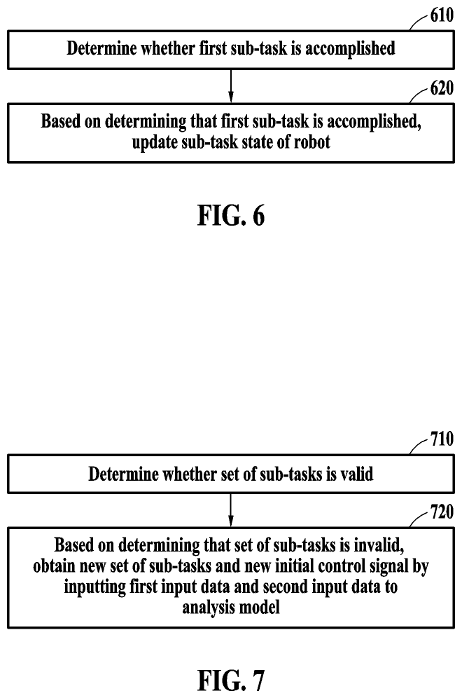

The electronic device may determine whether the first sub-task has been successfully accomplished when the robot is performing the first sub-task of the set of sub-tasks, and when the first sub-task is determined to have been accomplished, the electronic device may update the sub-task state of the robot so that the robot performs the second sub-task which follows the first sub-task (in the set of sub-tasks). A method of updating the sub-task state of the robot based on whether the first sub-task is accomplished is described with reference to FIG. 6.

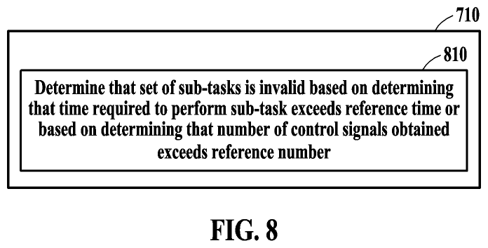

The electronic device may determine whether the set of sub-tasks is valid when the robot is performing the first sub-task of the set of sub-tasks, and when the set of sub-tasks is determined to be invalid, the electronic device may determine a new set of sub-tasks (or an updated set of sub-tasks) by operating in the plan mode. A method in which the electronic device operates based on whether the set of sub-tasks is valid and a method in which the electronic device determines whether the set of sub-tasks is valid are described with reference to FIGS. 7 and 8.

In operation 360, the electronic device may transmit the initial control signal or the first control signal to (or within) the robot. The robot may drive at least a part of the robot based on the initial control signal or the first control signal.

The electronic device may obtain a third image after the robot performs a movement corresponding to the initial control signal or the first control signal. The third image may be obtained with respect to a situation in which the robot and at least a part of the robot perform the task after the robot completes the movement corresponding to the first control signal. The electronic device may generate a second control signal by performing the method of controlling the robot of operations 310 to 360 based on the input prompt and the third image.

When the electronic device that controls the robot based on VLA technology newly (i) determines a movement (e.g., a sub-task) of the robot each time an image is obtained to obtain/generate the control signal of the robot and (ii) determines the control signal corresponding to the movement of the robot, since both an operation to calculate the movement of the robot and an operation to calculate the control signal of the robot are performed by the analysis model, significant time and resources may be required to obtain the control signal of the robot and the real-time performance of the robot control may be degraded. Since the electronic device operates either in the plan mode (in which the electronic device determines the set of sub-tasks indicating the movements of the robot to accomplish the task) or in the action mode (in which the electronic device determines only the control signal to accomplish the sub-task), time and resources required to obtain the control signal of the robot may be saved and the real-time performance of the robot control may be improved.

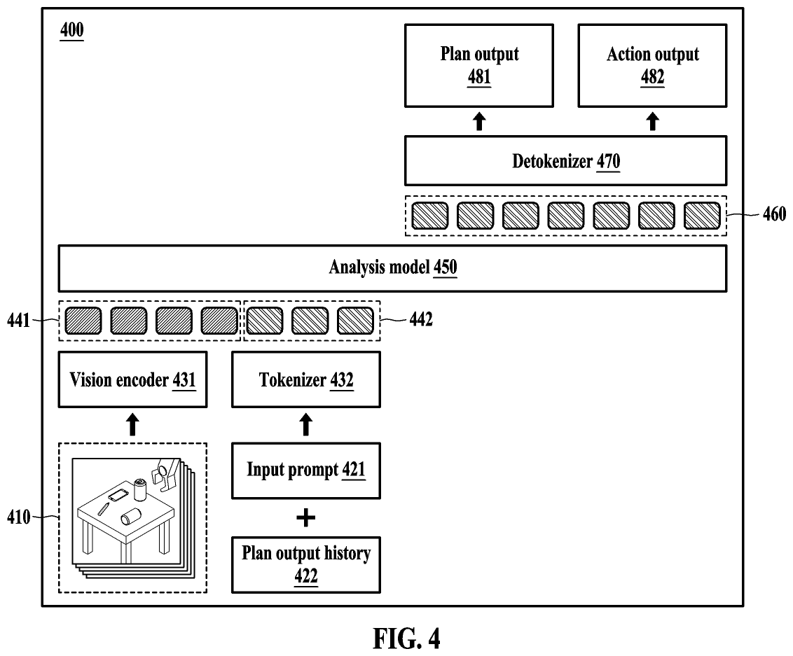

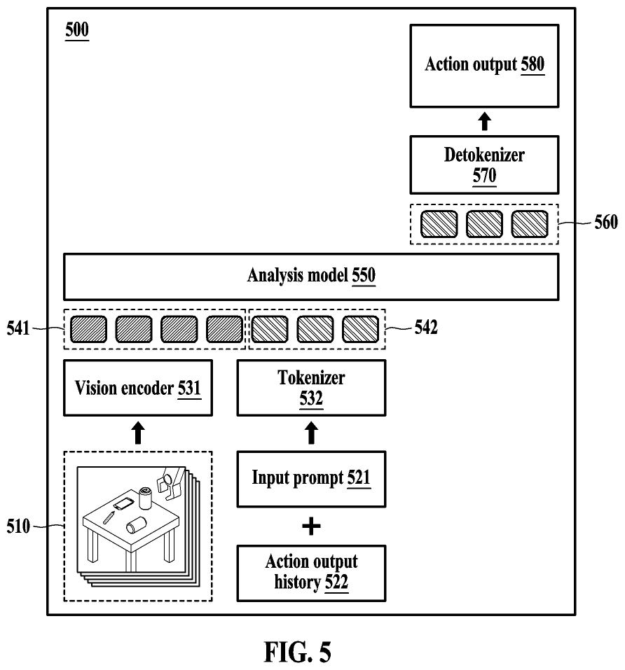

FIG. 4 illustrates an example of an operation in which an electronic device generates a plan-output and an action-output in a plan mode, according to one or more embodiments, and FIG. 5 illustrates an example of an operation in which the electronic device generates an action-output in an action mode, according to one or more embodiments. FIGS. 4 and 5 illustrate the same electronic device operating in the two different modes.

As noted, the electronic device may operate in a plan mode 400 or in an action mode 500. For example, the electronic device may differently generate pieces of image input data 441 and 541 and pieces of text input data 442 and 542 to be input to analysis models 450 and 550 (e.g., the analysis model 133 of FIG. 1) depending on whether the electronic device is in the plan mode 400 or in the action mode 500 and may input, to the analysis models 450 and 550 together with the pieces of image input data 441 and 541 and the pieces of text input data 442 and 542, a parameter that differently specifies contents of result tokens 460 and 560 to be generated by the analysis models 450 and 550.

As illustrated in FIG. 4, the electronic device operating in the plan mode 400 may generate a plan-output 481 and an action-output 482 based on a first image and an input prompt 421.

In the plan mode 400, the electronic device may generate, using a vision encoder 431, the image input data 441 (e.g., the second input data of FIG. 3) by processing an image set 410 including the first image. For example, the image set 410 may include the first image and a previously obtained image (obtained before the first image). The electronic device may generate, as the image input data 441, image tokens that accurately indicate an environment or a state corresponding to the first image by extracting image feature data of the first image with reference to the previously obtained image. For example, the image input data 441 may be image tokens (e.g., one-dimensional vectors) that may be processed by the analysis model 450.

In the plan mode 400, the electronic device may generate, using a tokenizer 432, the text input data 442 (e.g., the first input data of FIG. 3) by processing the input prompt 421 and a plan-output history 422. For example, the electronic device may generate the text input data 442 based on the result of concatenating the input prompt 421 with the plan-output history 422. The electronic device may generate the plan-output 481 indicating an improved set of sub-tasks based on feedback on the previously generated plan-output. For example, the text input data 442 may be text tokens(e.g., one-dimensional vectors) that may be processed by the analysis model 450.

In the plan mode 400, the electronic device may generate the result tokens 460 by inputting the image input data 441 and the text input data 442 to the analysis model 450. When the result tokens 460 are generated thereby, at least one result token that is generated earlier may also be input to the analysis model 450, together with the image input data 441 and the text input data 442, to generate subsequent result tokens 460.

In the plan mode 400, the electronic device may generate, using a detokenizer 470, the plan-output 481 and the action-output 482 by processing (e.g., performing inference on) the result tokens 460. The plan-output 481 may indicate a set of sub-tasks to accomplish a task corresponding to the input prompt 421. The action-output 482 may indicate a control signal of a robot (e.g., the robot 150 of FIG. 1) for performing a first task (of the set of sub-task). The electronic device may store the plan-output 481 and the action-output 482 in a memory and transmit the control signal corresponding to the action-output 482 to/within the robot.

As illustrated in FIG. 5, the electronic device operating in the action mode 500 may generate an action-output 580 based on a first image and an input prompt 521.

In the action mode 500, the electronic device may generate, using a vision encoder 531, the image input data 541 (e.g., the fourth input data of FIG. 1) by processing an image set 510 including the first image. For example, the image set 510 may include the first image and a previously obtained image (obtained before the first image). The electronic device may generate, as the image input data 541, image tokens that accurately indicate an environment or a state corresponding to the first image by extracting image feature data of the first image with reference to the previously obtained image. For example, the image input data 541 may be image tokens that may be processed by the analysis model 550.

In the action mode 500, the electronic device may generate, using a tokenizer 532, the text input data 542 (e.g., the third input data of FIG. 3) by processing the input prompt 521 and an action-output history 522. For example, the electronic device may generate the text input data 542 based on the result of concatenating the input prompt 521 with the action-output history 522. The electronic device may generate the action-output 580 that may accurately control the robot based on feedback on the previously generated action-output.

In the action mode 500, the electronic device may generate the result tokens 560 by inputting the image input data 541 and the text input data 542 to the analysis model 550. When the result tokens 560 are generated, at least one result token that was previously generated (e.g., from the action output history 522) may be input to the analysis model 550 together with the image input data 541 and the text input data 542 to generate the new result tokens 560.

In the action mode 500, the electronic device may generate, using a detokenizer 570, the action-output 580 by processing the result tokens 560. The action-output 580 may indicate a control signal that moves the robot so that a first sub-task that is currently being performed is accomplished. The electronic device may store the action-output 580 in a memory and transmit the control signal corresponding to the action-output 580 to the robot. The action-output 580 may also be stored in the action output history 522 immediately upon generation.

FIG. 6 illustrates an example of a method of updating a sub-task state of a robot, according to one or more embodiments.

Operations 610 and 620 below may be performed by an electronic device (e.g., the electronic device including the action generation model 130 of FIG. 1 or the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operations 610 and 620 may be performed after operation 360 described above with reference to FIG. 3 is performed.

The electronic device may determine whether a first sub-task is accomplished when a robot is performing the first sub-task of a set of sub-tasks. When the first sub-task is accomplished, the electronic device may update a sub-task state of the robot so that the robot performs a second sub-task performed after the first sub-task. The sub-task state of the robot may be a parameter indicating information about the sub-task that the robot is performing (or about to perform). The electronic device in an action mode may generate an action-output to accomplish the sub-task indicated by the sub-task state of the robot.

In operation 610, the electronic device may determine whether the first sub-task has been accomplished. For example, when the first sub-task is for moving an end effector to the position of a Coke can (e.g., “move end effector to Coke can”), whether the first sub-task has been accomplished may be determined based on the position of the end effector and the position of the Coke can appearing in a first image. For example, the electronic device operating in the action mode may generate an output indicating whether the first sub-task has been accomplished, together with the action-output, based on input data. For example, the electronic device may determine whether the first sub-task is accomplished by inputting, to a separate model, the first image and/or a signal sensed by a sensor related to the movement of the robot.

In operation 620, the electronic device may update the sub-task state of the robot so that the robot performs the second sub-task when the first sub-task has been accomplished. For example, when the electronic device generates a first action-output to accomplish the first sub-task based on the first image and then the sub-task state of the robot is updated to indicate the second sub-task, the electronic device may generate a second action-output to accomplish the second sub-task based on an image obtained after the first image.

The electronic device may generate the set of sub-tasks to accomplish a task, generate control signals so that each sub-task included in the set of sub-tasks is accomplished, and update the sub-task state of the robot so that the robot performs the next sub-task as the sub-task that is currently being performed is accomplished, thereby controlling the robot so that each sub-task of the set of sub-tasks is sequentially accomplished and the task is accomplished.

FIG. 7 illustrates an example of a method of controlling a robot based on whether a set of sub-tasks is valid, according to one or more embodiments.

Operations 710 and 720 below may be performed by an electronic device (e.g., the electronic device including the action generation model 130 of FIG. 1 or the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operations 710 and 720 may be performed after operation 360 described above with reference to FIG. 3 is performed.

In operation 710, the electronic device may determine whether a set of sub-tasks is valid. Validity of the set of sub-tasks depend on whether a determined sub-task set is suitable for accomplishing a task. For example, the electronic device may determine whether the set of sub-tasks is valid based on a signal indicating a failure in the movement of a robot or task accomplishment (e.g., as per a control signal for a sub-task). A method of determining whether the set of sub-tasks is valid is described with reference to FIG. 8.

In operation 720, the electronic device may operate in a plan mode to newly determine a set of sub-tasks when the current set of sub-tasks is determined to be invalid. The electronic device may obtain an updated/new set of sub-tasks to accomplish the task and an initial control signal of the robot to accomplish a first sub-task (of the new/updated set of sub-tasks) to be first performed by inputting, to an analysis model, first input data generated based on an input prompt and second input data generated based on a first image. The description of operation 340 above with reference to FIG. 3 is generally applicable to the description of operation 720. For example, as the first input data is generated based on a plan-output history indicating the set of sub-tasks determined to be invalid, the electronic device may reflect information of the set of sub-tasks determined to be invalid in generating the new/updates set of sub-tasks.

The electronic device may control the robot based on the new/updated set of sub-tasks by generating the same to accomplish the task when a failure occurs in accomplishing the task based on the previously determined set of sub-tasks.

FIG. 8 illustrates an example of a method of determining whether a set of sub-tasks is valid, according to one or more embodiments.

Operation 810 below may be performed by an electronic device (e.g., the electronic device including the action generation model 130 of FIG. 1 or the electronic device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operation 710 described above with reference to FIG. 7 may include operation 810.

The electronic device may determine whether a set of sub-tasks is valid, and depending on whether the set of sub-tasks is valid, the electronic device may generate a control signal of a robot based on an existing set of sub-tasks or may generate the control signal of the robot based on a new/updated set of sub-tasks.

In operation 810, the electronic device may determine that the set of sub-tasks is invalid when the time required to perform a first sub-task exceeds a reference time or when the number of control signals generated to perform the first sub-task exceeds a reference number. For example, when the first sub-task is for moving an end effector to the position of a Coke can (e.g., “move end effector to Coke can”), the electronic device may determine the reference time for the movement of the end effector. When the end effector does not reach the target point in the reference time (e.g., when an obstacle is positioned between the end effector and the Coke can), the electronic device may determine that the set of sub-tasks is invalid. As the set of sub-tasks is determined to be invalid, the electronic device may generate a new set of sub-tasks (e.g., a set of sub-tasks moving an end effector by bypassing an obstacle between the end effector and the Coke can).

Unlike as illustrated in FIG. 8, the electronic device may determine whether the set of sub-tasks is valid by inputting, to a separate model, the first image and/or a signal sensed by a sensor related to the movement of the robot. For example, when an object (e.g., a Coke can in a sub-task in which an end effector moves to the position of the Coke can), which is a reference to accomplish a sub-task, is not detected in the first image, the electronic device may determine that the sub-task is invalid. For example, the set of sub-tasks may be determined to be invalid when an impact, which is above a threshold value, is detected by at least one inertial sensor that is positioned at a joint of the robot. Whether the set of sub-tasks is valid may be determined based on various references, and the method of determining whether the set of sub-tasks is valid is not limited to the described examples.

The computing apparatuses, the robots, the electronic devices, the processors, the memories, the sensors/cameras, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of controlling a robot, the method comprising:
obtaining an input prompt indicating a task of the robot;
obtaining a first image for the robot;
determining which of a first process or a second process will be performed by determining whether a set of sub-tasks to accomplish the task is in effect;
the first process comprising
obtaining the set of sub-tasks to accomplish the task and an initial control signal of the robot to accomplish a first sub-task of the set of sub-tasks by inputting, to an analysis model, first input data generated based on the input prompt and second input data generated based on the first image, and
transmitting the initial control signal to or within the robot;
the second process comprising
obtaining a first control signal of the robot to accomplish the first sub-task of the set of sub-tasks by inputting, to the analysis model, third input data generated based on the input prompt and at least one control signal generated to accomplish the first sub-task and fourth input data generated based on the first image, and
transmitting the first control signal to or within the robot; and
performing whichever of the first and second processes is determined to be performed.

2. The method of claim 1, wherein the first process is performed, and wherein the method further comprises:
based on determining that the first sub-task has been accomplished by the robot according to the initial control signal, updating a sub-task state of the robot, the updating causing the robot to perform a second sub-task of the set of sub-tasks.

3. The method of claim 1, wherein the second process is performed, and wherein the method further comprises:
based on determining that the set of sub-tasks is invalid, obtaining a new set of sub-tasks for accomplishing the task and a new initial control signal of the robot to accomplish a first sub-task of the new set of sub-tasks by inputting the first input data and the second input data to the analysis model.

4. The method of claim 3, wherein the set of sub-tasks is determined to be invalid based on determining that a time required to perform the first sub-task exceeds a reference time or based on determining that a number of control signals, including the new initial control signal, obtained to perform the first sub-task exceeds a reference number.

5. The method of claim 1, wherein the first input data is generated based on the input prompt and sub-tasks previously generated to accomplish the task.

6. The method of claim 1, wherein the second input data or the fourth input data is generated based on the first image and a second image captured before the first image was captured.

7. The method of claim 1, wherein the analysis model is implemented based on all or part of a neural network, a transformer, a large language model (LLM), a vision language model (VLM), or a vision language action (VLA) model.

8. A non-transitory computer-readable storage medium storing instructions that, when executed by a processor, cause the processor to perform the method of claim 1.

9. An electronic device for controlling a robot, the electronic device comprising:
at least one processor including processing circuitry,
memory storing instructions that, when executed by the at least one processor individually or collectively, cause the electronic device to:
obtain an input prompt indicating a task of the robot;
obtain a first image for the robot;
determine which of a first process or a second process will be performed by determining whether a set of sub-tasks to accomplish the task is in effect;
wherein the first process comprises
obtaining the set of sub-tasks to accomplish the task and an initial control signal of the robot to accomplish a first sub-task of the set of sub-tasks by inputting, to an analysis model, first input data generated based on the input prompt and second input data generated based on the first image, and
transmitting the initial control signal to or within the robot;
wherein the second process comprises
obtaining a first control signal of the robot to accomplish the first sub-task of the set of sub-tasks by inputting, to the analysis model, third input data generated based on the input prompt and at least one control signal generated to accomplish the first sub-task and fourth input data generated based on the first image, and
transmitting the first control signal to or within the robot; and
perform whichever of the first and second processes is determined to be performed.

10. The electronic device of claim 9, wherein the first process is performed, and wherein the instructions, when executed by the at least one processor individually or collectively, further cause the electronic device to:
based on determining that the first sub-task has been accomplished by the robot according to the initial control signal, update a sub-task state of the robot, the updating causing the robot to perform a second sub-task of the set of sub-tasks.

11. The electronic device of claim 9, wherein the second process is performed, and wherein the instructions, when executed by the at least one processor individually or collectively, further cause the electronic device to:
based on determining that the set of sub-tasks is invalid, obtain a new set of sub-tasks for accomplishing the task and a new initial control signal of the robot to accomplish a sub-task to be first performed of the new set of sub-tasks by inputting the first input data and the second input data to the analysis model.

12. The electronic device of claim 11, wherein the instructions, when executed by the at least one processor individually or collectively, further cause the electronic device to determine that the set of sub-tasks is invalid based on determining that a time required to perform the first sub-task exceeds a reference time or based on determining that a number of control signals, including the new initial control signal, obtained to perform the first sub-task exceeds a reference number.

13. The electronic device of claim 9, wherein the first input data is generated based on the input prompt and sub-tasks previously generated to accomplish the task.

14. The electronic device of claim 9, wherein the second input data or the fourth input data is generated based on the first image and a second image captured before the first image was captured.

15. The electronic device of claim 9, wherein the analysis model is implemented based on all or part of a neural network, a transformer, a large language model (LLM), a vision language model (VLM), or a vision language action (VLA) model.

16. A method of controlling a robot, the method comprising:
obtaining an input prompt indicating a task of the robot;
obtaining a first image for the robot;
determining whether a set of sub-tasks to accomplish the task is in effect;
based on determining that the set of sub-tasks is in effect and the robot performing a first sub-task of the set of sub-tasks, obtaining a first control signal of the robot to accomplish the first sub-task by inputting, to an analysis model, third input data generated based on the input prompt and at least one control signal generated to accomplish the first sub-task and fourth input data generated based on the first image, and transmitting the first control signal to or within the robot.

17. The method of claim 16, further comprising:
obtaining a second input prompt indicating a second task of the robot;
obtaining a second image for the robot;
based on determining that a set of sub-tasks for the second task is not in effect, generating a second set of sub-tasks to accomplish the second task by inputting, to the analysis model, first input data generated based on the second input prompt and second input data generated based on the second image.

18. The method of claim 16, further comprising:
in response to the set of sub-tasks being determined to be in effect and the robot performing the first sub-task of the set of sub-tasks,
determining whether the set of sub-tasks is valid;
generating a new set of sub-tasks to accomplish the task and an initial control signal of the robot to accomplish a first sub-task of the new set of sub-tasks by inputting, to the analysis model, first input data generated based on the input prompt and second input data generated based on the first image, in response to the set of sub-tasks being determined to be invalid; and
transmitting the initial control signal to the robot.

19. The method of claim 18, wherein the set of sub-tasks is determined to be invalid based on a time required to perform the first sub-task exceeding a reference time or based on a number of control signals obtained to perform the first sub-task exceeding a reference number.

20. The method of claim 16, wherein the analysis model is implemented based on all or part of a neural network, a transformer, a large language model (LLM), a vision language model (VLM), or a vision language action (VLA) model.
